(19) United States
(12) Patent Application Publication
(10) Pub. No.: US 2020/0133707 A1
(43) Pub. Date: Apr. 30, 2020

(54) POWER EFFICIENT WORKLOAD PLACEMENT AND SCHEDULING IN A VIRTUALIZED COMPUTING ENVIRONMENT

(71) Applicant: T-Mobile USA, Inc., Bellevue, WA (US)

(72) Inventors: John Coster, Bellevue, WA (US); Quaid Campbell, Bellevue, WA (US); Don Doyle, Bellevue, WA (US); Keith Stenning, Bellevue, WA (US); Zach Denton, Bellevue, WA (US); Abhinav Sushanth Ganji, Bellevue, WA (US); Stephan Lagerholm, Bellevue, WA (US); Ashenafi Mendera, Bellevue, WA (US); Sean Seemann, Bellevue, WA (US)

(21) Appl. No.: 16/661,536

(22) Filed: Oct. 23, 2019

Related U.S. Application Data
(60) Provisional application No. 62/750,235, filed on Oct. 24, 2018.

(51) Int. Cl. G06F 9/455; G06F 16/23; G06F 1/28

(52) U.S. Cl. CPC G06F 9/45558; G06F 2009/45591; G06F 1/28; G06F 16/2379

(57) ABSTRACT

An apparatus referred to as a profiling server monitor receives data corresponding to the operation of physical hardware in a virtual computing environment. An example is power consumption data. The profiling server monitor analyzes the data received and determines an operation to perform or a business rule to follow in order to, as one example, reduce power consumption of the virtual computing environment.

### CROSS-REFERENCE TO RELATED APPLICATION(S)

This application is a nonprovisional of and claims the benefit under 35 U.S.C. 119(e) of U.S. Provisional Patent Application No. 62/750,235, filed Oct. 24, 2018, entitled “Power Efficient Workload Placement and Scheduling in a Virtualized Computing Environment,” the contents of which are incorporated by reference as if fully disclosed herein.

### TECHNICAL FIELD

Embodiments described herein relate to virtualized computing environments and, in particular, to systems and methods for minimizing power consumption in a virtualized or containerized computing environment.

### BACKGROUND

Virtualization and containerization are known techniques to distribute access to shared physical hardware resources (e.g., processors, memory, network connections, and so on) among multiple “virtual machines” or “containers” that, in turn, can be ordered on demand and configured in a suitable manner to execute one or more computational workloads.

However, as a result of the separation of execution of computational workloads from specific underlying physical hardware, it often is difficult to characterize, profile, or otherwise estimate real-time or cumulative power utilization attributable to the creation and/or operation of a virtual machine or a container or power utilization attributable to the execution of a particular computational workload by a particular virtual machine or container.

### SUMMARY

Embodiments described herein reference an apparatus configured to receive power consumption data related to the operation of physical hardware in a virtual computing environment and, thereafter, to analyze the data to inform orchestration decisions, workload placement decisions, and/or workload scheduling decisions, in the virtual computing environment to reduce power consumption.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 is a schematic representation of a system, such as described herein, configured to inform workload placement and/or scheduling in a virtual computing environment based, at least in part, on power consumption by physical hardware resources associated with that virtual computing environment.

FIG. 2A is a simplified signal flow diagram corresponding to a system, such as described herein, configured to profile and monitor power consumption of a hosted virtual computing environment.

FIG. 2B is a simplified signal flow diagram corresponding to a system, such as described herein, configured to monitor power consumption of a native virtual computing environment.

FIG. 2C is a simplified signal flow diagram corresponding to a system, such as described herein, configured to monitor power consumption of a containerized virtual computing environment.

FIG. 3 is a flow chart that depicts example operations of a method of profiling and/or monitoring power consumption of a virtual computing environment, such as described herein.

FIG. 4 is a flow chart that depicts example operations of a method of using a power consumption profile in a virtual computing environment, such as described herein.

FIG. 5 is a flow chart that depicts example operations of a method of performing orchestration operations in a virtual computing environment based on power consumption by physical hardware resources associated with that virtual computing environment, such as described herein.

FIG. 6 is a flow chart that depicts example operations of a method of performing workload placement and/or workload scheduling operations in a virtual computing environment based on power consumption by physical hardware resources associated with that virtual computing environment, such as described herein.

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein reference systems and methods for guiding and influencing virtual machine orchestration, workload placement, workload design, workload scheduling, and/or other operational characteristics of, or associated with, a virtual computing environment based, at least in part, on real-time or substantially real-time analysis of one or more operational characteristics (e.g., power consumption, processor utilization, and so on) of the physical hardware resources (e.g., processors, memory, storage, network connections, and so on) supporting that virtual computing environment.

As a result of these and other described and equivalent systems and methods, virtual computing environments, and, in particular, large-scale datacenters supporting virtual computing environments, may be operated in a substantially more efficient manner.

As used herein, the phrase “virtual computing environment” refers to any system, technique, or architecture implemented to distribute access to shared physical hardware resources (e.g., processors, memory, network connections, and so on) among one or more instances of one or more “virtual machines” or “containers.” As such, it may be appreciated that a virtual computing environment, such as described herein, may refer to any suitable known or later-developed technique, design, or architecture for hardware virtualization (including virtual processors, virtual memory, virtual network connections, and the like), network virtualization, storage virtualization, memory virtualization, containerization, and/or any combination thereof whether such virtualization or containerization is configured to aggregate multiple physical hardware resources into a single virtual machine or container, is configured to distribute access to physical hardware resources among multiple virtual machines or containers, or any combination thereof.

For simplicity of description, many embodiments described herein reference a virtual computing environment including a server (also referred to as a “computer”) that accommodates a hypervisor software layer (a “hypervisor”) that, in turn, presents a virtual hardware interface for use by a virtual machine. The virtual hardware interface either can mirror the physical hardware architecture of the server or, additionally or alternatively, can abstract an arbitrary physical hardware architecture for use by the virtual machine. For example, a hypervisor software layer can instantiate a virtual hardware interface including a virtual processor, a virtual memory, and/or a virtual network connection that, in turn, can host one or more virtual computing resources or environments, such as a virtual machine or a container. It may be appreciated, however, that this implementation of a virtual computing environment is merely one example; in other cases, containerization or other virtualization topologies may be used.

As noted above, embodiments described herein reference systems and methods for adjusting the operation of a virtual computing environment based, at least in part, on real-time or substantially real-time monitoring and profiling of one or more operational characteristics of a server (or cluster of servers) supporting that virtual computing environment.

More specifically, these embodiments include a “profiling server monitor” (also referred to as a “telemetry monitor”) that is communicably coupled to, and configured to obtain data or information from one or more data sources such as, without limitation: the server; a hypervisor or container engine accommodated on the server; a local or remote power source or utility (which may include an intermediate power supply or source, such as power converters, generators, backup or redundant supplies, uninterruptable power supplies, and so on) supplying the server with electrical power; a passive or in-line power probe (e.g., current clamp, power meter, and so on) configured to measure power consumption of the power source and/or the server and to output one or more power consumption characteristics (e.g., power consumption, power use over time, current, voltage, and so on); a server sensor configured to monitor one or more environmental properties (e.g., temperature, humidity, airflow, condensation, light brightness, smoke alarms, coolant leaks and so on); a cooling or coolant system associated with the sensor; a server or blade enclosure; a keyboard-video-mouse switch or other local or remote administration tool; network switches; packet inspectors; a third-party service (e.g., a utility company application programming interface); an application or service executed by a virtual machine operating in the virtual computing environment; and so on.

More specifically, the profiling server monitor of embodiments described herein can be configured to poll, receive, query, and/or subscribe to telemetry and/or diagnostic data reports (originating from one or more data sources) that correspond to real-time or substantially real-time operation of the server that supports the virtual computing environment (e.g., by measuring power output in real-time from a power supply coupled to a physical computing resource). Example telemetry or diagnostic data (which may be time-stamped, tagged, or otherwise presented alongside, or logically associated with, metadata or other descriptive data) that can be received by the profiling server monitor can include one or more of, but may not be limited to: power consumption data; temperature data; humidity data; airflow data; processor utilization data; memory utilization data; storage utilization data; network traffic and/or utilization data; security data; computational load data; historical sensor data; and so on.

In addition, in some embodiments, the profiling server monitor can receive or determine statistical metadata associated with the operation of the virtual computing environment. For example, statistical metadata related to power consumption (as one example) can include, but may not be limited to: average power consumption; peak power consumption; peak, average, or root-mean-squared voltage or current; minimum power consumption; power source jitter; standard deviation and/or variation in power consumption within a selected time window; and so on.

In addition, in some embodiments, the profiling server monitor can receive data (e.g., via an application programming interface) related to a server, a hypervisor, and/or one or more hardware components communicably coupled to, or otherwise associated with, the virtual computing environment. Examples include, but may not be limited to: network address data; hypervisor type data (e.g., Type 1 or Type 2); hypervisor provider or manufacturer data; server provider or manufacturer data; server or hypervisor maintenance schedule data; power source provider or manufacturer data; power supply provider or manufacturer data; and so on. In some cases, the received data may be an identifier or fingerprint that uniquely identifies particular hardware, particular software, or a combination thereof.

In still further embodiments, the profiling server monitor can receive additional data from additional data sources not listed above; it is appreciated that any suitable data or metadata can be received by the profiling server monitor.

The profiling server monitor can be configured to implement any suitable data intake, ingest, and/or processing architecture to receive, process, and/or store the data and/or information received asynchronously or synchronously from the one or more data sources. Example data processing architectures that may be suitable for use by a profiling server monitor such as described herein include, but are not limited to: lambda architectures; sigma architectures; kappa architectures; batch processing architectures; streaming database architectures; event stream processing architectures; complex event processing architectures; and so on.

Once received, the data obtained by the profiling server monitor can be processed and/or otherwise analyzed by the profiling server monitor in any suitable manner. In many cases, the profiling server monitor leverages a machine learning algorithm or model (e.g., decision trees, state machines, genetic or evolutionary algorithms, machine learning algorithms, support vector machine algorithms, neural networks, Bayesian networks, gradient learning algorithms, and so on) to analyze the data received.

In some examples, the profiling server monitor analyzes the data received from the one or more data sources in order to profile or fingerprint one or more characteristics exhibited by a virtual computing environment when a particular virtual machine operating on a particular server accommodating a particular hypervisor executes a particular workload.

For example, execution of a particular workload by a particular virtual machine may result in a power consumption signature and memory utilization signature that can be recognized by the profiling server monitor by analyzing, in substantially real-time, data received from a power consumption probe coupled to the power supply of a server and data received from a hypervisor. In this example, once the profiling server monitor recognizes the power consumption signature and the memory utilization signature, the profiling server monitor can infer that execution of the associated workload has been initiated by the particular virtual machine.

In another example, the operation of ordering of (also referred to as “spinning up”) a specifically-configured virtual machine from a particular hypervisor may result in a detectable signature that can be recognized by the profiling server monitor by analyzing processor utilization data received from the hypervisor or the server.

In yet another example, the operation of terminating a particular workload or shutting down a particular virtual machine may result in a detectable acoustic signature that can be recognized by the profiling server monitor by analyzing acoustic data received from an acoustic sensor positioned nearby the server.

More generally, it may be appreciated that a suitable machine learning algorithm (or combination, cooperation, or workflow including multiple machine learning, data normalization, or other algorithms) can be trained from sample data to identify (and/or disaggregate) specific signatures and/or fingerprints attributable to a particular workload, a particular virtual machine, a particular server, a particular hypervisor, or a combination thereof from data received by the profiling server monitor from one or more data sources, such as the example data sources listed above.

As a result of these constructions, a profiling server monitor, such as described herein, can be used to automatically supervise, oversee, and/or otherwise control or influence the behavior of a virtual computing environment for any suitable purpose. Examples include, but may not be limited to: verifying whether a vendor of virtual computing services is using power-efficient virtualization technology (e.g., power-efficient servers, power-efficient hypervisors or container engines, and so on); verifying whether a vendor of virtual computing services is complying with a service-level agreement (e.g., using specified servers, hypervisors, maximum power consumption levels, and so on); placing a particular workload on a particular virtual machine associated with a particular server or particular hypervisor to reduce power consumption associated with executing that workload; scheduling a particular workload on a particular virtual machine associated with a particular server or particular hypervisor to reduce power consumption associated with executing that workload; migrating a particular workload from one virtual machine to another to reduce power consumption associated with executing that workload; scheduling or adjusting orchestration staggering, timing, or placement of one or more virtual machines to reduce power consumption; and so on.

Accordingly, generally and broadly, embodiments described herein reference a profiling server monitor configured to ingest and process telemetric and/or diagnostic data associated with the operation of physical hardware in a virtual computing environment in order to influence the distribution of workloads, the ordering or stopping of virtual machines, the scheduling of workloads, the selection of particular server hardware, the selection of particular hypervisors or container engines (e.g., particular versions, particular manufacturers, and so on), and so on. For simplicity of description, many embodiments described herein reference a profiling server monitor configured to influence one or more of (1) virtual machine ordering and configuration orchestration, (2) workload placement, and (3) workload scheduling in a virtual computing environment to reduce power consumption, but it is appreciated that this is merely one example.

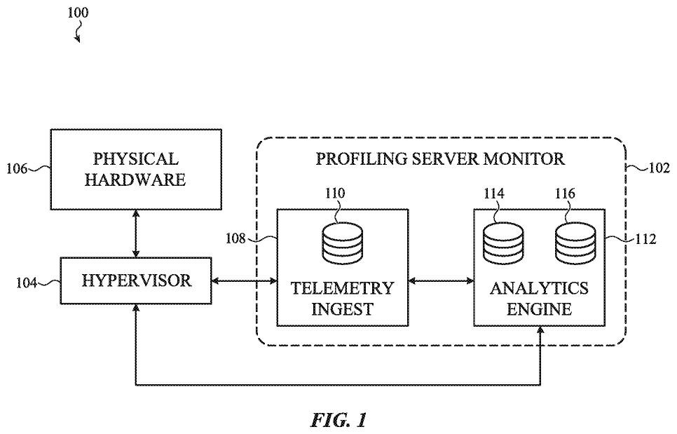

These foregoing and other embodiments are discussed below with reference to FIGS. 1-6. However, those skilled in the art will readily appreciate that the detailed description given herein with respect to these figures is for explanatory purposes only and should not be construed as limiting.

FIG. 1 is a schematic representation of a system, such as described herein, configured to inform workload placement and/or scheduling in a virtual computing environment based, at least in part, on power consumption by physical hardware resources associated with that virtual computing environment.

In particular, the system 100 includes a profiling server monitor 102 configured to operate with a virtual computing environment that is supported by a server accommodating a hypervisor 104 and including one or more physical hardware resources including, but not limited to (or requiring) one or more of: a processor; a memory; storage; networking connections; and so on. The physical hardware resources of the server are identified in the figure as the physical hardware 106.

The profiling server monitor 102 in the illustrated example is communicably coupled to the hypervisor 104 to receive telemetry data from the hypervisor 104 as the hypervisor 104 operates to serve the virtual computing environment. As noted with respect to other embodiments described herein, the hypervisor 104 can communicate any suitable information or data to the profiling server monitor 102 including, but not limited to: power consumption data; temperature data; humidity data; acoustic data; visual data (e.g., camera footage); processor utilization data; core utilization data; memory utilization data; storage utilization data; networking data; manufacturer data; virtual machine identifying data; hypervisor identifying data; and so on. It may be appreciated that any suitable data can be communicated from the hypervisor 104 to the profiling server monitor 102 at any suitable rate, in any suitable format, according to any suitable protocol, in a synchronous or asynchronous matter, whether encrypted or unencrypted. In the illustrated embodiment, the profiling server monitor 102 includes a telemetry ingest module 108 that receives data from the hypervisor 104. In some cases, such as illustrated, the telemetry ingest module 108 optionally includes a transitory or non-transitory memory store or database, identified as the database 110.

In some cases, the telemetry ingest module 108 may include one or more hardware or software components configured to communicably couple to the hypervisor 104. For example, in some embodiments, the telemetry ingest module 108 includes a software module configured to interface with an application programming interface hosted or otherwise provided by the hypervisor 104. In other cases, the telemetry ingest module 108 can include a dedicated processor or circuit configured to conductively or wirelessly couple to a communication module of the hypervisor 104.

Once data—regardless of form or format—is received by the telemetry ingest module 108 of the profiling server monitor 102, it can be analyzed by an analytics engine 112. As noted with respect to other embodiments described herein, the analytics engine 112 can be configured to record, process, and/or analyze the data received from the hypervisor 104 in order to influence or guide one or more operations of the virtual computing environment, such as workload placement and/or workload scheduling.

For example, in some embodiments, the analytics engine 112 administers an algorithm configured to monitor power consumption of the physical hardware 106 as a particular workload is executed by a virtual machine of the virtual computing environment. In this example, the analytics engine 112 can track power consumption over time, correlating power usage—as reported by the hypervisor 104 and/or another power-reporting component (not shown), such as a power probe, a power meter, or an electrical utility—to one or more performance characteristics of the workload, such as processor utilization, memory utilization, storage utilization, and so on.

As a result of this construction, the analytics engine 112 can determine and/or observe how performance of a particular workload executed on a particularly configured virtual machine affects power consumption of the physical hardware 106. For example, in some cases, the hypervisor 104 may determine a need to allocate more processing power or memory to the workload if the workload begins loading the physical hardware 106 beyond a selected threshold. In this example, the analytics engine 112, having received processor utilization, memory utilization, and/or power consumption data over time from the hypervisor 104 (via the telemetry ingest module 108) can determine a power consumption cost associated with the reallocation of resources performed by the hypervisor 104. An operation such as described in this example, in which a profiling server monitor—such as described herein—determines or characterizes one or more relationships between two or more variables associated with the operation of a virtual computing environment, is referred to herein as a “profiling operation.”

In other embodiments, the analytics engine 112 of the profiling server monitor 102 can perform additional or alternative profiling operations. Examples include, but are not limited to: profiling power consumption as a function of a particular hypervisor manufacturer given a particular workload executed by a particular virtual machine; profiling power consumption as a function of a particular hypervisor type or version given a particular workload executed by a particular virtual machine; profiling power consumption as a function of a particular physical hardware given a particular workload executed by a particular virtual machine; profiling speed of execution and power consumption as a function of a particular hypervisor, a particular physical hardware, or a particular combination thereof, given a particular workload executed by a particular virtual machine; profiling uptime as a function of power consumption and as a function of a particular hypervisor, a particular physical hardware, or a particular combination there given a particular workload executed by a particular virtual machine; and so on.

It may be appreciated that the foregoing examples are not exhaustive; an analytics engine of a profiling server monitor, such as the analytics engine 112 of the profiling server monitor 102 depicted in FIG. 1 can be configured to perform any number of suitable profiling operations, the results of which may be stored/inserted/added in any suitable form or format in a database (such as the database 114) or may be communicated to another component or system (not shown), such as another analytics engine or another profiling server monitor.

It may be appreciated that the operation of creating, updating, or storing results of a profiling operation (herein, a “profile”) can be performed by a profiling server monitor at any suitable time. For example, in some embodiments, a profiling server monitor can perform a profiling operation relating a certain set of variables or values only once. In other cases, a profiling server monitor can perform profiling operations regularly, on a schedule, in response to a certain condition, or at any suitable time.

It may be appreciated that, generally and broadly, a profile, such as described herein, can be used by a profiling server monitor to inform a number of decisions that can improve the efficiency—especially the power use efficiency—of a virtual computing environment.

In other words, in many embodiments, a profiling server monitor—such as described herein—can be configured to automatically extract, infer, or otherwise create, edit, or update one or more “business rules” based on one or more profiles stored in the database 114. These business rules can, in turn, be stored in, and accessed from, a business rules database 116.

As may be appreciated, business rules can inform and/or otherwise guide the operation of a virtual computing environment—such as the virtual computing environment associated with the system 100 depicted in FIG. 1—and may be used to determine, without limitation: what hypervisor type should be preferred or used given a particular selected workload; what virtual machine image or configuration should be preferred or used given a particular hypervisor type; what vendor or vendor service(s) should be preferred or used to order a virtual machine to perform a selected workload; whether a selected workload should be throttled or accelerated at a particular time of day or given a particular demand or load condition; where a selected workload should be placed and/or executed; at what time or under what conditions a selected workload should be executed; whether resources should be overcommitted for a particular workload or particular virtual machine; whether a selected virtual machine should be resident on the same physical hardware as another selected virtual machine; whether a selected workload should be transferred, migrated, or transitioned to another virtual machine or other physical hardware; whether a selected workload should be paused, terminated, or throttled in favor of a different selected workload; whether one or more physical hardware components should be powered down entirely; whether orchestration of the ordering of one or more virtual machines should be performed at a particular time; whether provisioning of a particular virtual machine should be performed or delayed; whether repair or replacement of failed physical hardware should be prioritized or performed; and so on. It may be appreciated that this listing of example business rules is not exhaustive; any suitable business rule may be extracted, inferred, or otherwise created, edited, or updated by analyzing (e.g., using a machine learning algorithm or other suitable analysis technique) one or more profiles created or stored by the profiling server monitor 102.

For example, the profiling server monitor 102 may be able to determine, by comparing two or more profiles, that a first workload executed by a virtual machine supported by a Type 1 hypervisor consumes less power than the same workload executed by the same virtual machine supported by a Type 2 hypervisor. In this example, the profiling server monitor 102 may create a business rule that causes the virtual computing environment to request or prefer a virtual machine supported by a Type 1 hypervisor when the first workload is required to be executed.

In another example, the profiling server monitor 102 may be able to determine, by comparing two or more profiles, that execution of a second workload, different from the first workload, is associated with increased power consumption when executed on a virtual machine resident on the same physical hardware as the virtual machine executing the first workload. In this example, the profiling server monitor 102 may create a business rule that causes the virtual computing environment to request or prefer separate physical hardware when it is required that the first and second workloads are simultaneously executed. In this manner, and as a result of this construction, power consumption associated with the execution of the first and second workloads can be reduced.

In another example, the profiling server monitor 102 may be able to determine, by comparing two or more profiles, that execution of a workload is associated with increased power consumption when executed on a virtual machine hosted by a first virtual computing services vendor compared to execution of the same workload executed on a virtual machine hosted by a second virtual computing services vendor. In this example, the profiling server monitor 102 may create a business rule that causes the virtual computing environment to request or prefer virtual machines hosted by the second virtual computing services vendor. In this manner, and as a result of this construction, power consumption associated with the execution of the workload is reduced.

The foregoing embodiments depicted in FIG. 1 and the various alternatives thereof and variations thereto are presented, generally, for purposes of explanation, and to facilitate an understanding of various configurations and constructions of a profiling server monitor, such as described herein. However, it will be apparent to one skilled in the art that some of the specific details presented herein may not be required in order to practice a particular described embodiment, or an equivalent thereof.

For example, in some embodiments, a profiling server monitor may be configured to prefer performance to power consumption reduction in certain circumstances defined by one or more business rules. In other cases, a profiling server monitor may be configured to prefer service availability to power consumption reduction.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

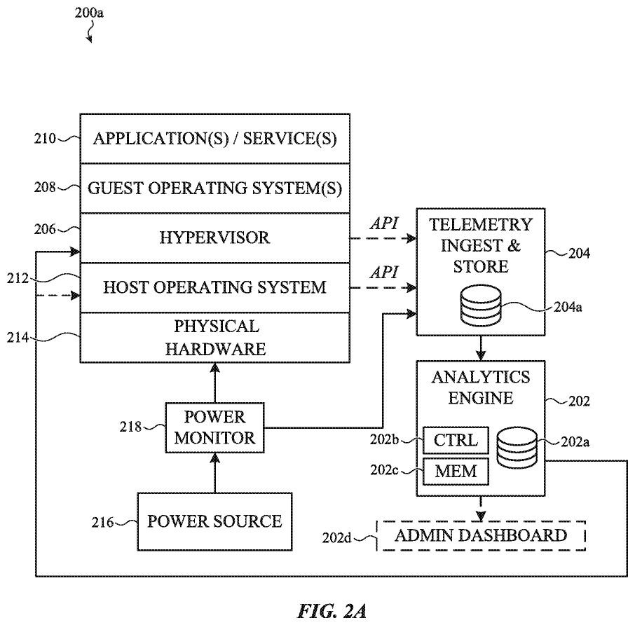

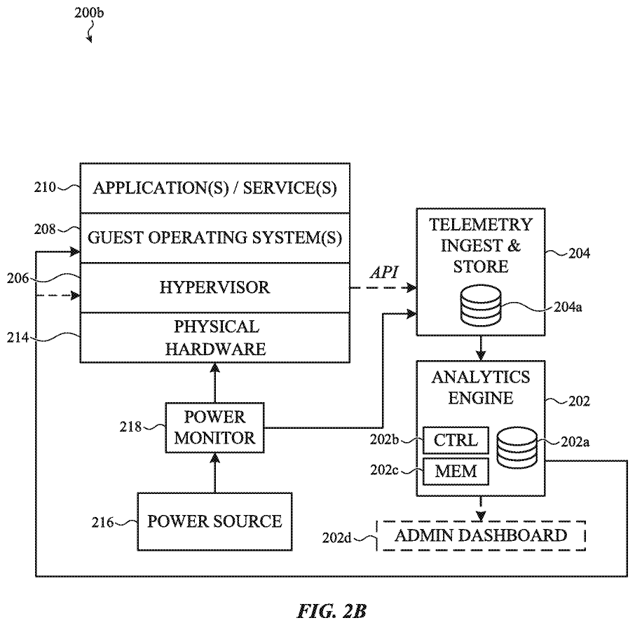

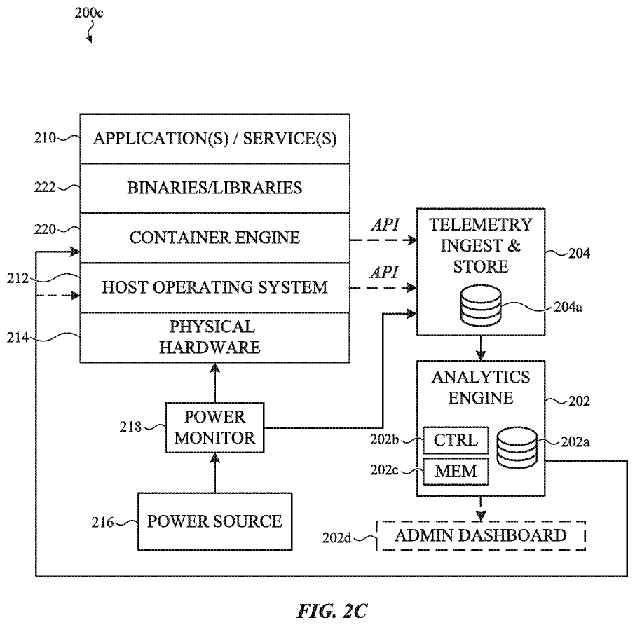

Generally and broadly, FIGS. 2A-2C each depict simplified signal flow diagrams corresponding to different virtualization techniques and technologies that can be coupled to, or otherwise associated, with a profiling server monitor such as described herein. In particular, FIG. 2A references a virtualization system including a hosted hypervisor, FIG. 2B references a virtualization system including a bare metal hypervisor, and FIG. 2C references a containerization system including a container engine. Each of these virtualization topologies—along with equivalents thereof—can be communicably coupled to one or more profiling server monitors, such as described herein. Accordingly, it may be appreciated that each of these systems can be profiled by and operated according to business rules determined, preferred, or enforced by a profiling server monitor such as described herein.

For example, FIG. 2A is a simplified signal flow diagram corresponding to a system, such as described herein, configured to profile a hosted virtual computing environment. The system 200a, similar to the system 100 depicted in FIG. 1, includes a profiling server monitor that is implemented with an analytics engine 202 and a telemetry ingest module 204. As with other embodiments described herein, the telemetry ingest module 204 receives telemetry or diagnostic data—such as power usage data, temperature data, airflow data, and so on—from, among other data sources, a hosted hypervisor.

The hosted hypervisor, identified as the hypervisor 206, is configured to present a virtual hardware interface for one or more guest operating system(s) 208 that, in turn, can each execute one or more computational workloads, such as one or more applications or services 210.

The hypervisor 206 is installed over a host operating system 212. The host operating system 212 is, in turn, installed over, and configured to directly interface with, one or more physical hardware resources including, but not limited to (or requiring) one or more of: a processor; a memory; storage; networking connections; and so on. These physical hardware resources are collectively identified in the figure as the physical hardware 214.

As noted with respect to other embodiments described herein, the profiling server monitor of the system 200a is configured to receive and analyze telemetry data and/or diagnostic data from one or more data sources in order to, as one example, profile one or more operations or operational characteristics of the depicted virtual computing environment.

For example, the telemetry ingest module 204 can be communicably coupled to, and thus can receive telemetry and/or diagnostic data from, the hypervisor 206 via an application programming interface. Example data that can be communicated from the hypervisor 206 to the telemetry ingest module 204 includes, but may not be limited to: processor utilization data; memory utilization data; aggregate power consumption data; storage utilization data; and so on.

In further examples, the telemetry ingest module 204 can be (optionally) communicably coupled to, and thus can receive telemetry and/or diagnostic data from, the host operating system 212 via a second application programming interface. Example data that can be communicated from the host operating system 212 to the telemetry ingest module 204 includes, but may not be limited to: hypervisor analytics data; hypervisor process usage data; power consumption data; processor utilization data; memory utilization data; storage utilization data; networking statistics; and so on.

In some cases, the telemetry ingest module 204 may receive the same or similar data from more than one data source. For example, in some embodiments, the telemetry ingest module 204 may receive power consumption data from both the hypervisor 206 and from the host operating system 212. In these examples, the telemetry ingest module 204 can optionally de-duplicate and/or combine data from different data sources before communicating that data to the analytics engine 202. In one embodiment, the telemetry ingest module 204 can be configured to average a first power consumption value received from the hypervisor 206 with a second power consumption value received from the host operating system 212. In other cases, the telemetry ingest module 204 can be configured to reject the lower of the two values.

In still further examples, the telemetry ingest module 204 can receive data from other data sources. For example, in some embodiments, a power source 216 supplying electrical power to the physical hardware 214 may include or may otherwise be coupled to a power sensor, a power probe, or a power monitor. An example power monitor is identified in the figure as the power monitor 218. Example power monitors include, but are not limited to: current clamp power monitors; in-line current or voltage power monitors; uninterruptable power supplies; backup generators; battery backup or redundant power systems; and so on.

In these embodiments, the telemetry ingest module 204 can be communicably coupled to, and thus can receive telemetry and/or diagnostic data from, the power monitor 218 via an application programming interface or any other suitable communication connection. Example data that can be communicated from the power monitor 218 to the telemetry ingest module 204 includes, but may not be limited to: real-time processor utilization data; real-time electrical current data; changes in power supplied by the power source 216 or consumed by the physical hardware 214; and so on.

It may be appreciated that the foregoing example data sources that may supply a telemetry ingest module, such as described herein, are not exhaustive. Further, it may be appreciated that power consumption data may not be required or preferred to be supplied to a telemetry ingest module. As noted with respect to other embodiments described herein, a telemetry ingest module can be communicably coupled to any number of suitable data sources to receive any suitable telemetry or diagnostic data corresponding to the operation of, or an operational characteristic of, a virtual computing environment, such as described herein.

Regardless of source, once data is received by the telemetry ingest module 204, it may be stored in a database 204a, either temporarily or for a period of time, prior to being communicated to the analytics engine 202 for further processing. In some examples, the telemetry ingest module 204 may be further configured to perform one or more data normalization, formatting, encrypting, or enriching (e.g., supplementing received data with known data or metadata) operations prior to storage in the database 204a and/or prior to communicating with the analytics engine 202.

As noted with respect to other embodiments described herein, once data is received by the telemetry ingest module 204, it may be communicated to the analytics engine 202 for profiling and/or the creation of one or more business rules, such as described above. The various example methods and/or operations that can be performed by an analytics engine in response to data received from a telemetry ingest module are described in detail in reference to other embodiments described herein, and are not repeated here.

It may be appreciated that an analytics engine, such as described herein, can be implemented in a number of suitable ways. For example, in many implementations, the analytics engine 202 includes a database 202a, (e.g., a profile database and/or a business rules database), circuitry and/or logic components, (such as a processor 202b), and/or one or more transitory or non-transitory memory modules (such as the memory 202c).

In some cases, the analytics engine 202 can also be optionally configured to generate a graphical user interface at a local or remote administration display to interact with and/or provide information to a user; an example administrative dashboard is identified in the figure as the dashboard 202d.

Generally and broadly, it may be appreciated that the various components of the analytics engine 202 can cooperate to control or coordinate some or all of the operations of the analytics engine 202 including, but not limited to, (1) receiving data from the telemetry ingest module 204, (2) performing profiling operations on data received from the telemetry ingest module 204, and/or (3) developing or extracting business rules based on the results of one or more profiling operations.

It may be further appreciated that the processor 202b of the analytics engine 202 can be implemented as any software or physical electronic device (or combination thereof) capable of processing, receiving, or transmitting data or instructions. For example, the processor 202b can be a microprocessor, a central processing unit, an application-specific integrated circuit, a field-programmable gate array, a digital signal processor, an analog circuit, a digital circuit, or combination of such devices. The processor 202b may be a single-thread or multi-thread processor. The processor 202b may be a single-core or multi-core processor.

Accordingly, as described herein, the phrases “processing unit,” “controller,” and “processor” are used interchangeably and refer to software and/or hardware-implemented data processing devices or circuits physically and/or structurally configured to execute instructions or program code to instantiate one or more classes or objects that are purpose-configured to perform specific transformations of data including operations represented as code and/or instructions included in a program that can be stored within, and accessed from, a memory such as the memory 202c. These terms are meant to encompass a single processor or processing unit, multiple processors, multiple processing units, analog or digital circuits, or other suitably configured computing element or combination of elements.

The example embodiment depicted in FIG. 2A is merely one example; in other cases, such as the system 200b shown in FIG. 2B, a host operating system may not be required. In this example, the hypervisor 206 is installed directly over the physical hardware 214. In this example embodiment, the host operating system 212 shown in FIG. 2A is not available as a data source for the telemetry ingest module 204.

In still further examples, as noted above, containerization may be used in place of hardware virtualization. For example, as shown in FIG. 2C, a system 200c includes a container engine 220 installed over the host operating system 212. The container engine 220 provides an interface for a binary/library container layer 222 that provides dependency support to run the one or more applications or services 210.

The foregoing embodiments depicted in FIGS. 2A-2C and the various alternatives thereof and variations thereto are presented, generally, for purposes of explanation, and to facilitate an understanding of various configurations and constructions of a virtual computing environment that incorporates or is communicably coupled to a profiling server monitor, such as described herein. However, it will be apparent to one skilled in the art that some of the specific details presented herein may not be required in order to practice a particular described embodiment, or an equivalent thereof.

For example, it may be appreciated that a profiling server monitor, such as described herein, need not necessarily include a telemetry ingest module that is logically, functionally, or physically different or separate from an analytics engine; in some cases a single module or engine can perform the tasks of each.

Furthermore, it may be appreciated that a profiling server monitor can receive data from any number of suitable data sources, including those not depicted in FIGS. 2A-2C. For example, in some embodiments, a profiling server monitor can be communicably coupled to an application or service executing within a virtual machine. In other cases, a profiling server monitor can be communicably coupled to a container engine or a binary/library container layer. In still further examples, more than one profiling server monitors can be communicably coupled to one another.

As such, generally and broadly, it may be appreciated that a profiling server monitor, such as described herein, is configured to receive data—regardless of the source of that data—and to analyze that data in order to inform or modify the operation of a virtual computing environment by creating and/or modifying business rules based on insights obtained by one-time or ongoing profiling of the operation of that virtual computing environment. In many embodiments, as noted above, a profiling server monitor is configured to prefer business rules that minimize power consumption, but this is merely one example.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

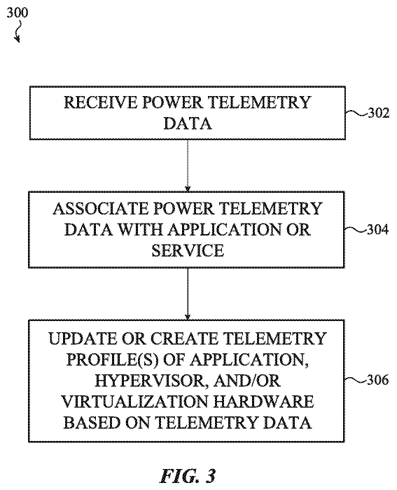

Generally and broadly, FIGS. 3-6 depict flow charts corresponding to example simplified methods of operating a system, such as described herein, to profile and/or monitor power consumption in a virtual computing environment.

FIG. 3 is a flow chart that depicts example operations of a method of profiling and/or monitoring power consumption of a virtual computing environment, such as described herein. The method 300 may be performed by a profiling server monitor, such as described herein. More particularly, the method 300 may be performed by a processor, or a set of processors, associated with a telemetry ingest module or an analytics engine of a profiling server monitor such as described herein.

The method 300 includes operation 302 in which telemetry data related to power consumption of physical hardware is received. The scale, resolution, form, and format of the power data, along with the units with which the power consumption data is presented, may vary from embodiment to embodiment. In some cases, the power consumption data is received from a power probe, a power monitor, or other data source that is external to the physical hardware components consuming the power to be measured. Examples include a current clamp dispose around an input or an output of a power supply coupled to the physical hardware components consuming the power to be measured. In other cases, the power consumption data is received from the physical hardware components consuming the power to be measured.

The method 300 also includes operation 304 in which the received power data is associated with a particular workload known to be currently executing in a virtual machine or container hosted by the physical hardware currently consuming power.

The method 300 also includes operation 306 in which a power profile is created or updated based, at least in part, on the association formed at operation 304. In some cases, more than one profile can be created or updated; for example, a first profile associating a particular hypervisor with the power data received at operation 302 can be created or updated while a second power profile associating the physical hardware with the power data received at operation 302 is created or updated.

As noted with respect to other embodiments described herein, the profile(s) created and/or updated at operation 306 can be stored in a database for future access.

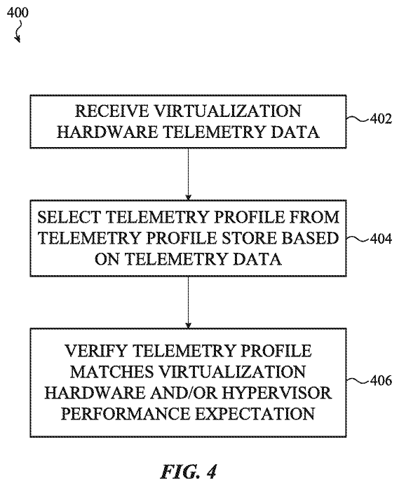

FIG. 4 is a flow chart that depicts example operations of a method of using a power consumption profile in a virtual computing environment, such as described herein. As with the method 300, the method 400 may be performed by a profiling server monitor, such as described herein. More particularly, the method 400 may be performed by a processor, or a set or cluster of processors, associated with a telemetry ingest module or an analytics engine of a profiling server monitor such as described herein.

The method 400 includes operation 402 in which telemetry data related to the operation of physical hardware used for virtualization is received. Example telemetry data that can be received includes, but may not be limited to: uptime; downtime; processor utilization; memory utilization; storage utilization; over-commitment information; under-commitment information; power consumption information; and so on.

As with other embodiments described herein (see, e.g., FIG. 3), it may be appreciated that the scale, resolution, form, and format of the received telemetry data, along with the units with which the telemetry data is presented, may vary from embodiment to embodiment. In some cases, the telemetry data is received from a hypervisor, a host or guest operating system, an application, power probe, a power monitor, or other data source.

The method 400 includes operation 404 in which a telemetry profile is selected from a set of previously-stored telemetry profiles based on the data obtained at operation 402. Phrased in another way, operation 404 determines whether the data obtained at operation 402 is closely associated with (e.g., similar to a mathematical or statistical degree) a known or existing profile.

The method 400 also includes operation 406 in which information contained in the telemetry profile selected at operation 404 matches a performance expectation of the physical hardware associated with the selected telemetry profile. For example, a profiling server monitor may receive telemetry data, such as a power consumption pattern, that substantially matches a known telemetry profile of a specific server. In this example, once the known telemetry profile is selected, the profiling server monitor can determine whether the server is performing (e.g., executing workloads) as expected. In this manner, as one example, a profiling server monitor can be used to verify a vendor's compliance with a service-level agreement for virtual computing environment services.

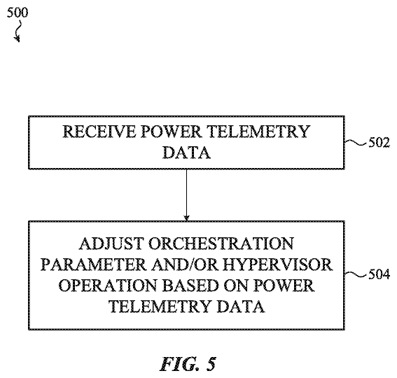

FIG. 5 is a flow chart that depicts example operations of a method of performing orchestration operations in a virtual computing environment based on power consumption by physical hardware resources associated with that virtual computing environment, such as described herein. As with the methods 300, 400 the method 500 may be performed by a profiling server monitor, such as described herein. More particularly, the method 500 may be performed by a processor, or a set or cluster of processors, associated with a telemetry ingest module or an analytics engine of a profiling server monitor such as described herein.

The method 500 includes operation 502 in which power consumption data related to the operation of physical hardware used for virtualization is received. Next, at operation 504, an orchestration parameter and/or an operation of a hypervisor or container engine can be adjusted based, at least in part, on the power consumption data received at operation 502. For example, if physical hardware is consuming more power than expected, the profiling server monitor may instruct or otherwise cause one or more workloads or virtual machines to be migrated away from the inefficiently-consuming physical hardware. As a result of this technique, efficient power consumption of a virtual computing environment can be maintained.

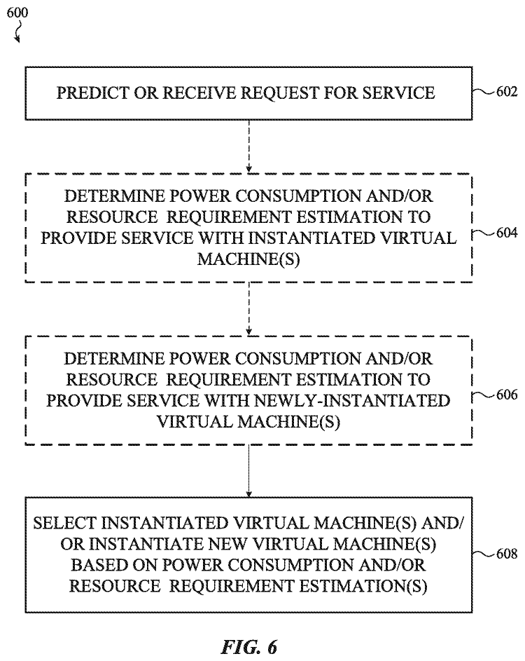

FIG. 6 is a flow chart that depicts example operations of a method of performing workload placement and/or workload scheduling operations in a virtual computing environment based on power consumption by physical hardware resources associated with that virtual computing environment, such as described herein. As with the methods 300-500 the method 600 may be performed by a profiling server monitor, such as described herein. More particularly, the method 600 may be performed by a processor, or a set or cluster of processors, associated with a telemetry ingest module or an analytics engine of a profiling server monitor such as described herein.

The method 600 includes operation 602 in which a workload (e.g., an application or a service) is requested or scheduled to be executed. Next, optionally, a power consumption profile can be determined, selected, and/or predicted based, at least in part, on the requested or scheduled workload. Thereafter, optionally, at operation 604, the profiling server monitor can determine whether existing instances of virtual machines can service the request to execute the selected workload in a power efficient manner. Phrased in another manner, at operation 604, the profiling server monitor can estimate an amount of power consumption (e.g., a power consumption cost) associated with executing the workload with one or more existing virtual machines.

Similarly (optionally) at operation 606, the profiling server monitor can determine whether one or more new instances of virtual machines can service the request to execute the selected workload in a power efficient manner. Phrased in another manner, at operation 606, the profiling server monitor can estimate an amount of power consumption (e.g., a power consumption cost) associated with executing the workload with one or more new virtual machines.

At operation 608, the profiling server monitor selects whether to service the workload on an existing virtual machine or to instantiate a new virtual machine to service the workload. In many cases, the profiling server monitor may selected the option that results in the most power efficient executing or servicing of the workload which may, or may not, be the fastest or most time efficient method of executing or servicing the workload.

The foregoing embodiments depicted in FIGS. 3-6 and the various alternatives thereof and variations thereto are presented, generally, for purposes of explanation, and to facilitate an understanding of various methods of operating a profiling server monitor, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

What is claimed is:

1. A system for profiling power consumption of a virtual computing environment, the system comprising:
a power supply;
a server receiving power from the power supply, the server comprising a processor configured to:
execute first computer program code stored in a memory to instantiate a hypervisor software layer that defines a virtual hardware interface comprising:
a virtual processor; and
a virtual memory;
execute second computer program code stored in the memory to instantiate a telemetry monitor communicably coupled to a power probe configured to measure power output from the power supply; and
a virtual machine instantiated by third computer program code stored in the virtual memory and executed by the virtual processor, the virtual machine configured to execute a workload; wherein
the telemetry monitor is configured to:
generate a power consumption profile associating an input received from the power probe to an identifier associated with one or more of the workload, the virtual machine, the virtual hardware interface, the hypervisor software layer, or the server; and
insert the power consumption profile into a database in communication with the server.

2. The system of claim 1, wherein the input comprises a power consumption characteristic received from the power probe.

3. The system of claim 2, wherein the power consumption characteristic comprises:
average power consumption;
peak power consumption;
peak, average, or root-mean-squared voltage or current;
minimum power consumption;
power source jitter; or standard deviation and/or variation in power consumption within a selected time window.

4. The system of claim 1, wherein:
the power supply is a primary power supply;
the input is a first input; and
the system comprises a backup power supply; wherein
the telemetry monitor is communicably coupled to the backup power supply and is configured to generate the power consumption profile associating a second input received from the backup power supply to the identifier.

5. The system of claim 1, wherein the power probe comprises a current clamp.

6. The system of claim 1, wherein the telemetry monitor is configured to generate or update the power consumption profile after receiving a signal that the virtual machine is performing the workload.

7. The system of claim 1, wherein the telemetry monitor is configured to generate or update the power consumption profile after receiving a signal that the workload has been executed by the virtual machine.

8. The system of claim 1, wherein the telemetry monitor is configured to generate or update the power consumption profile after receiving a signal that the virtual machine is instantiated.

9. The system of claim 1, wherein the telemetry monitor is configured to generate or update the power consumption profile after receiving a signal that the hypervisor software layer is instantiated.

10. A system for profiling power consumption of a virtual computing environment, the system comprising:
a power supply configured to report a measurement of power output from the power supply;
a server cluster receiving power from the power supply, at least one server of the server cluster configured to execute computer program code to instantiate a hypervisor software layer that defines a virtual hardware interface by allocating a physical resource of at least two servers of the server cluster to define a virtual processor and a virtual memory; and
a second server communicably coupled to the power supply and the hypervisor software layer, the second server configured to monitor power consumption of the server cluster as a function of utilization of the allocated physical resource(s) while a virtual machine or container instantiated over the virtual hardware interface executes a given workload.

11. The system of claim 10, wherein the second server is configured to monitor power consumption of the server cluster as a function of an environmental property reported by at least one server of the server cluster.

12. The system of claim 10, wherein the environmental property comprises one or more of:
a temperature;
a humidity;
airflow;
condensation; or
light brightness.

13. The system of claim 10, wherein the second server is configured to monitor power consumption of the virtual processor as a function of power consumption of the server cluster.

14. The system of claim 10, wherein the second server is configured to monitor power consumption of the virtual memory as a function of power consumption of the server cluster.

15. The system of claim 10, wherein the second server is configured to monitor power consumption of the hypervisor software layer as a function of one or more of:
power consumption of the server cluster as reported by the power supply;
power consumption of the server cluster as reported by the hypervisor software layer;
power consumption of the server cluster as reported by a power consumption probe configured to measure a power output of the power supply;
power consumption of the virtual machine as reported by the virtual machine;
power consumption of the power supply as reported by the power supply; or
power consumption of the hypervisor software layer as reported by the hypervisor software layer.

16. A system for profiling power consumption of a workload executed in a virtual computing environment, the system comprising:
a cluster of servers, each respective server configured to:
receive power from at least one power supply;
execute computer program code to define at least a portion of a virtual hardware interface by allocating at least a portion of a physical computing resource of the respective server; and
a profiling server communicably coupled to cluster of servers, the profiling server configured to monitor power consumption of each respective server of the cluster of servers having allocated at least a portion of at least one computing resource of the respective server to define the virtual hardware interface while the virtual hardware interface is used to execute the workload.

17. The system of claim 16, wherein the physical computing resource comprises:
a processor;
a memory; or
a networking controller.

18. The system of claim 16, wherein the workload is executed by a container of the virtual computing environment.

19. The system of claim 16, wherein the profiling server is configured to monitor a power consumption characteristic comprising:
average power consumption;
peak power consumption;
peak, average, or root-mean-squared voltage or current;
minimum power consumption;
power source jitter; or
standard deviation and/or variation in power consumption within a selected time window.

20. The system of claim 19, wherein the power consumption characteristic is associated with the workload.
